(19) United States
(12) Patent Application Publication
(10) Pub. No.: US 2023/0145140 A1
(43) Pub. Date: May 11, 2023

(54) ECO-FRIENDLY UNDERWATER BUOY AND MANUFACTURING METHOD THEREFOR

(71) Applicants: Kidong KIM, Seoul (KR); Byoungyoung JUNG, Seoul (KR)

(72) Inventors: Kidong KIM, Seoul (KR); Byoungyoung JUNG, Seoul (KR)

(21) Appl. No.: 17/917,094

(22) PCT Filed: Apr. 6, 2021
(86) PCT No.: PCT/KR2021/004286

§ 371 Date: Oct. 5, 2022

(30) Foreign Application Priority Data
Apr. 6, 2020 (KR) 10-2020-0041745

(51) Int. Cl. B63B 22/00

(52) U.S. Cl. CPC B63B 22/00; A01K 71/00

(57) ABSTRACT

The present invention provides an eco-friendly underwater buoy and a manufacturing method therefor, the underwater buoy comprising: a liner main body of which the inside is hollow; a winding member which is melt welded on the outer surface of the liner main body by winding, and which absorbs external shock; and buoy couplers embedded in both ends of the liner main body so as to couple adjacent underwater buoys to each other. The present invention winds, through filament winding, a wire, in which a glass fiber, a resin and the like are mixed, around the outside of a liner structure so as to manufacture an underwater buoy, and thus, since the underwater buoy is made of a composite material, the appearance of the buoy structure can be stably maintained for a long time without damage caused by various underwater shocks, so that underwater environmental pollution caused by buoy structure damage can be minimized, thereby maximizing the eco-friendliness of the underwater buoy.

### TECHNICAL FIELD

The present invention relates to an eco-friendly underwater buoy and a method of manufacturing the same, and particularly, to an eco-friendly underwater buoy in which, since a wire in which a glass fiber, a resin, and the like are mixed is wound outside a liner structure through a filament winding method to manufacture an underwater buoy, it is possible to stably maintain an exterior of a buoy structure for a long time, thereby minimizing environmental pollution in water due to damage on the buoy structure, and a method of manufacturing the same.

### BACKGROUND ART

In general, buoys floating on water are used to mark a specific position on a water surface in the ocean, lake, or river. Such buoys usually have a specific gravity less than the specific gravity of water to float on the water by buoyancy and are formed and used in a form of which a restoring force is increased such that the buoy can always stand upright against an external force like a buoy. Such underwater buoys are usually made of a foam polystyrene (styrofoam) material. In particular, such ocean buoys are usually used by directly connecting styrofoam buoys or spherical plastic buoys wrapped with in a net using an anchor line. In addition, fishermen connect the ocean buoys to each other to perform fishing net work or to install the ocean buoys in a laver or seaweed farm or the like.

Then, when the above-described conventional underwater buoy is described with reference to FIG. 1, the conventional underwater buoy includes a buoy body 70 formed in a cylindrical shape having a certain diameter, a groove portion 71 having a groove with a certain size formed in a circumferential direction on an outer peripheral surface of each of both end portions of the buoy body 70, and a fixing means 72 coupled to the groove portion 71 to connect adjacent buoys. Here, the buoy body 70 is made of a foam polystyrene (Styrofoam) material, and the fixing means 72 is usually formed of a rope. Here, when the underwater buoy 73 is described in more detail, the underwater buoy 73 is manufactured in various forms applied to various aquaculture, most of the buoys typically have a cylindrical shape and are provided with the groove portion 71 extending in the circumferential direction on an outer peripheral surface such that the buoys can be tied with a rope.

Meanwhile, when a method of using the above-described conventional underwater buoy is described, after a plurality of buoy body 70 made of a styrofoam material tare moved to the ocean or other necessary places, the rope, which is the fixing means 72, is tied to the groove portion 71 formed on each of both end portions of the buoy body 70 to complete the assembly of the underwater buoy 73. In this case, the underwater buoy 73 is made of styrofoam to have buoyancy in the water and thus floats on the water at an appropriate height. In addition, a connection ring or an iron wire 74 is coupled to the rope which is the fixing means 71 of the underwater buoy 73 assembled as described above and then is coupled to a rope of another adjacent buoy body 73. Therefore, the underwater buoys 73 coupled in the above manner are installed in a fishing net or installed in a laver or seaweed farm or the like.

However, the conventional underwater buoys as described above are mostly made of styrofoam. Since such styrofoam has weak physical properties and is brittle, when the conventional underwater buoy is used for a long time, for example, due to the influence of waves or wind in the ocean, a portion wrapped with a rope is very easily broken and easily damaged. A bigger problem is that styrofoam of the damaged buoy is split into thousands of smaller pieces and piled up on a seafloor, which acts as a factor that greatly pollutes an underwater environment and also causes a problem in that the pieces are pushed to a shore by waves or wind and are left unattended in various places to considerably spoil the beauty. Furthermore, when the conventional underwater buoy as described above is broken, fine styrofoam pieces floating in seawater are spread and eat by fish, resulting in a problem that causes secondary damage to humans.

### DISCLOSURE

### Technical Problem

Accordingly, the present invention is invented to solve the above problems of a related art and is directed to provide an eco-friendly underwater buoy in which an underwater buoy is made of a composite material and thus is not damaged from various impacts in water to maintain an exterior of a buoy structure for a long time, thereby minimizing environmental pollution in water due to damage on the buoy structure, and a method of manufacturing the same.

The present invention is also directed to provided an eco-friendly underwater buoy which has a structure in which a metal coupling means is formed in each of both end portions of an underwater buoy structure to connect other underwater buoy structures to each other, thereby allowing fishing net work and fish farm installation work to be easily performed, and a method of manufacturing the same.

### Technical Solution

According to an aspect of the present invention, there is provided an eco-friendly underwater buoy including a liner body having an inner hollow portion; a winding member which is melted and welded on an outer surface of the liner body through a winding method and absorbs an external impact; and a buoy coupler which is formed to be embedded in each of both end portions of the liner body and connects other adjacent underwater buoys to each other, wherein the buoy coupler is embedded in each of the both end portions of the liner body simultaneously when the liner body is molded and includes: a bushing member which includes a screw rod with a rod shape in which a male thread is formed on an outer surface of one end portion of a body, and a circumferential plate with a certain diameter integrally formed under the screw rod; and a coupling ring which has a first nut coupling hole and which is rotatably fixed to both external ends of a body and is formed in a ring shape such that other objects are hung and coupled thereto, wherein the first nut coupling hole is formed to pass through an inner side of the coupling ring to a rear end thereof to have a certain diameter such that the screw rod of the bushing member is inserted and nut-coupled to the rear end and has a male thread formed inside the body such that the screw rod of the bushing member is screw-coupled thereto.

According to one embodiment of the present invention, the liner body may be made of high density polyethylene (abbreviated to HDPE).

According to one embodiment of the present invention, the winding member may be a structure formed integrally on the outer surface of the liner body by winding a wire made of a glass fiber mixed with a curing agent and a resin.

According to another aspect of the present invention, there is provided an eco-friendly underwater buoy including a liner body having an inner hollow portion; a winding member which is melted and welded on an outer surface of the liner body through a winding method and absorbs an external impact; and a buoy coupler which is formed to be embedded in each of both end portions of the liner body and connects other adjacent underwater buoys to each other, wherein the buoy coupler is embedded in each of the both end portions of the liner body simultaneously when the liner body is molded and includes: a bushing member which includes a screw rod protruding outward in a rod shape and having a fixing hole formed in one side of an end portion thereof and a circumferential plate with a certain diameter integrally formed under the screw rod; and a fixing wire which is insertion-coupled to the fixing hole of the bushing member to serve as a hook.

According to one embodiment of the present invention, the bushing member and the buoy coupler may be made of any one selected from an alloy and stainless steel.

According to still another aspect of the present invention, there is provided a method of manufacturing an eco-friendly underwater buoy, the method including a first process of molding and producing a liner body having a certain shape through a liner blower machine and concurrently embedding and molding a bushing member in each of both end portions of the liner body; a second process of, after the first process, performing a liner flaming process of heat-treating an outer surface of the liner body with plasma; a third process of, after the second process, coupling a shaft to the bushing member formed in the liner body and winding a glass fiber wire, in which a curing agent and a resin are mixed, on the outer surface of the liner body in a set pattern through a filament winding method to form a composite buoy having a form of an underwater buoy; a fourth process of, after the third process, drying the composite buoy inside a drying furnace by repeating transferring and rolling to then cool the composite buoy at room temperature for a certain time and separating the shaft from the composite buoy to then perform various inspections including a pressure-resistance inspection; and a fifth process of, after the fourth process, connecting a set buoy coupler to each of both sides of the composite buoy passing the inspection to complete an underwater buoy, wherein the first process includes a liner molding process of molding and producing the liner body having the certain shape through the liner blower machine (not shown) and concurrently embedding and molding the bushing member in each of the both end portions of the liner body; a scrap removing operation of, when the liner body is taken out to the outside in the liner molding operation, transferring the taken-out liner body to a set place through a conveyor to then remove marks or scraps on the outer surface of the liner body; and a liner aging and drying operation of, after the scrap removing operation, performing an operation of drying and aging the liner body, from which the scraps are removed, at a set temperature for a set time through the conveyor (not shown) to write a dimension.

According to one embodiment of the present invention, the second process may further include a liner flaming operation of heat-treating the outer surface of the liner body using oxygen plasma.

According to one embodiment of the present invention, the third process may further include a shaft coupling operation of coupling the shaft to the bushing member formed in the liner body; and a filament winding operation of, after the shaft coupling operation, allowing a plurality of glass fiber strands or wires to pass through a mixing module (not shown) to be mixed with the resin and the curing agent and then filament-winding the mixed glass fiber wire in the set pattern on the outer surface of the liner body to form the composite buoy having the form of the underwater buoy.

According to one embodiment of the present invention, the fourth process may further include a buoy drying operation of moving the composite buoy to the drying furnace using a moving means (not shown) coupled to the shaft and repeating the transferring and rolling to then dry the composite buoy; a cooling operation of, after the buoy drying operation, performing a process of exposing the dried composite buoy to air at room temperature for 15 minutes to 40 minutes to cool the composite buoy; and a final inspection operation of separating the shaft from the composite buoy cooled in the cooling operation to then perform the various inspections including the pressure-resistance inspection.

According to one embodiment of the present invention, the fifth process may further include a process operation of connecting any one of a fixing wire and a coupling ring to each of both sides of the composite buoy passing the inspection to complete the underwater buoy.

### Advantageous Effects

According to the present invention as described above, by manufacturing an underwater buoy by winding a wire, in which a glass fiber and a resin are mixed, outside a liner structure through a filament winding method, the underwater buoy is made of a composite material and thus is not damaged from various impacts in water to stably maintain an exterior of a buoy structure for a long time, thereby minimizing environmental pollution in water due to damage on the buoy structure.

Furthermore, in the present invention as described above, since an underwater buoy has a structure in which a metal coupling means is formed in each of both end portions of an underwater buoy structure to connect other underwater buoy structures to each other, fishing net work and fish farm installation work can be easily performed, thereby obtaining the convenience of underwater work.

### DESCRIPTION OF DRAWINGS

FIG. 1 is an explanatory view for describing an example of a conventional underwater buoy.

FIG. 2 is an explanatory view for describing one embodiment of a composite buoy according to an eco-friendly underwater buoy of the present invention.

FIG. 3 is an explanatory view for describing another embodiment of a composite buoy according to an eco-friendly underwater buoy of the present invention.

FIG. 4 is an image for describing an example of a liner body of an eco-friendly underwater buoy of the present invention.

FIGS. 5A and 5B are explanatory views for describing one embodiment of FIG. 2 in more detail.

FIGS. 6A and 6B are explanatory views for describing another embodiment of FIG. 3 in more detail.

FIGS. 7A and 7B are explanatory views for describing an example of a filament winding pattern during a process of manufacturing an eco-friendly underwater buoy of the present invention.

FIG. 8 is an explanatory view for describing a brief use state applied to the embodiment of FIG. 5A.

FIG. 9 is an explanatory view for describing a brief use state applied to the embodiment of FIG. 6A.

FIG. 10 is a flowchart of the present invention.

### MODES OF THE INVENTION

The present invention may be modified in various ways and implemented by various embodiments so that specific embodiments are illustrated in the drawings and will be described in detail below. However, it should be understood that there is no intention to limit the present invention to the specific embodiments, and on the contrary, the present invention is to cover all modifications, equivalents, and alternatives falling within the spirit and scope of the present invention. In describing the present invention, when the detailed description of the relevant known function or configuration is determined to unnecessarily obscure an important point of the present invention, the detailed description will be omitted.

While terms such as “first,” “second,” and the like may be used to describe various components, such components must not be understood as being limited to the above terms. These terms are only used for the purpose of distinguishing one element from another element.

It is to be understood that terms used herein are for the purpose of the description of particular embodiments and not for limitation. A singular expression includes a plural expression unless the context clearly indicates otherwise. It will further be understood that the terms “comprises” and/or “comprising,” when used in this specification, specify the presence of stated features, integers, steps, operations, elements, components, and/or groups thereof but do not preclude the presence or addition of one or more other features, integers, steps, operations, elements, components, and/or groups thereof.

In addition, in describing the present invention, when the detailed description of the relevant known function or configuration is determined to unnecessarily obscure an important point of the present invention, the detailed description will be omitted.

Hereinafter, embodiments of the present invention will be described in detail with reference to the related drawings.

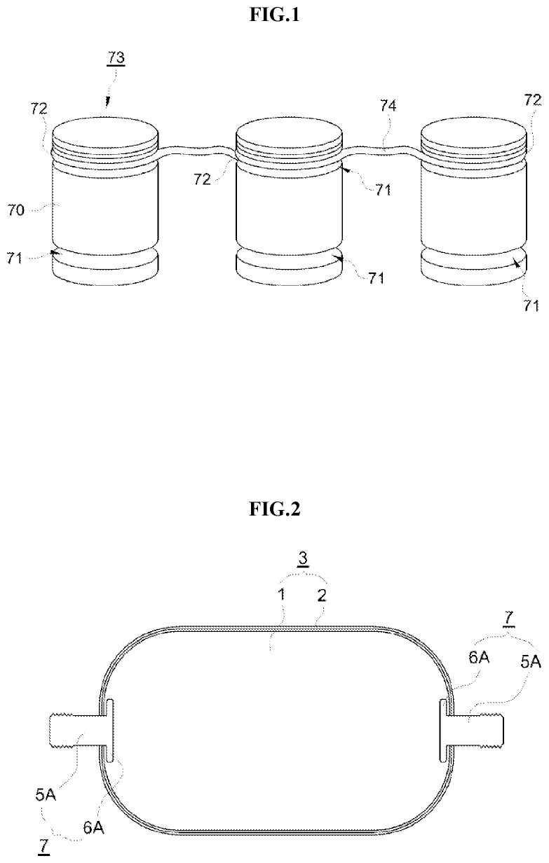

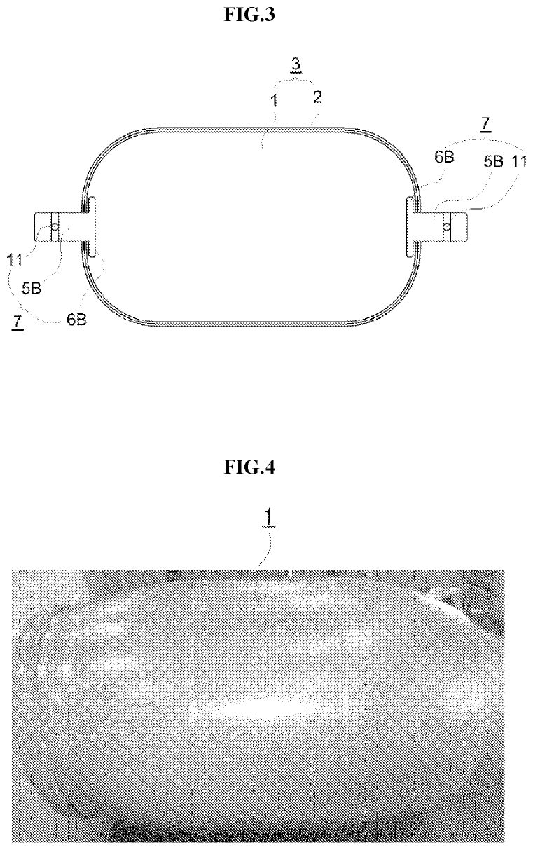

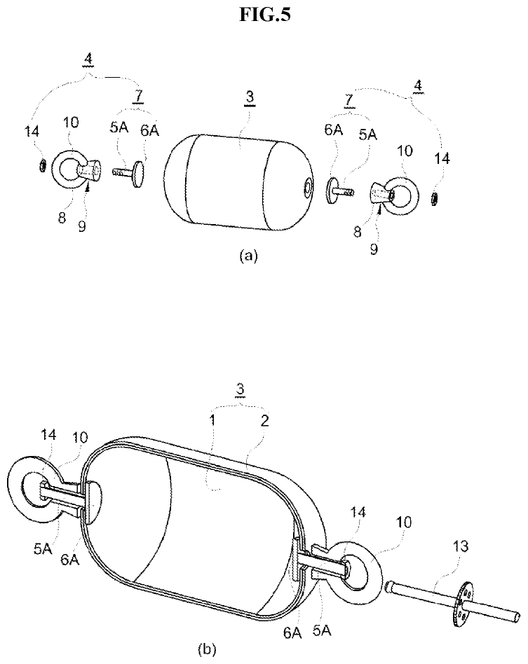

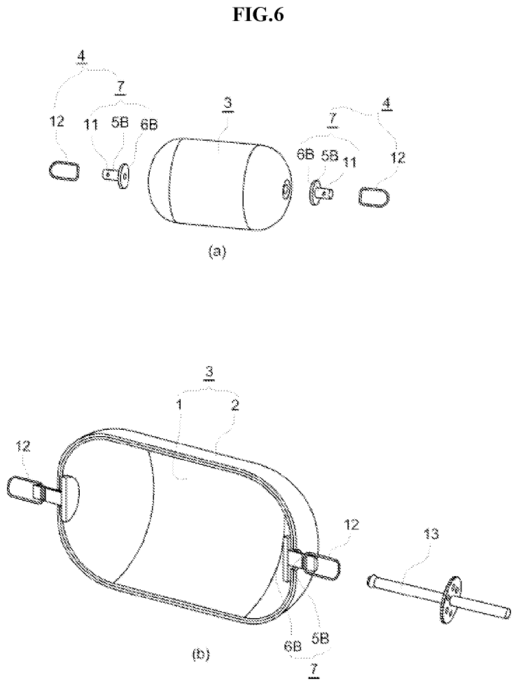

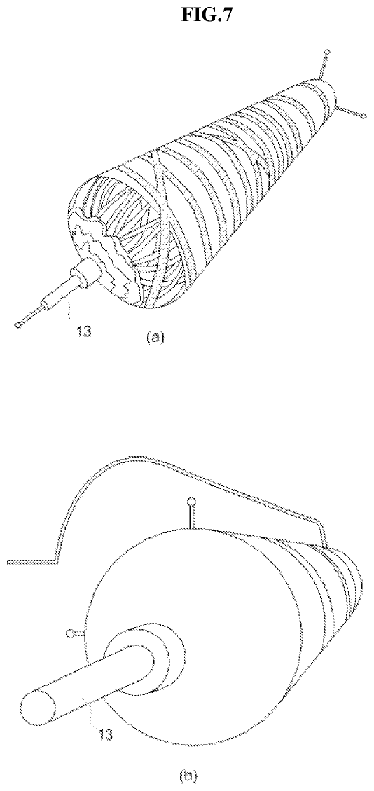

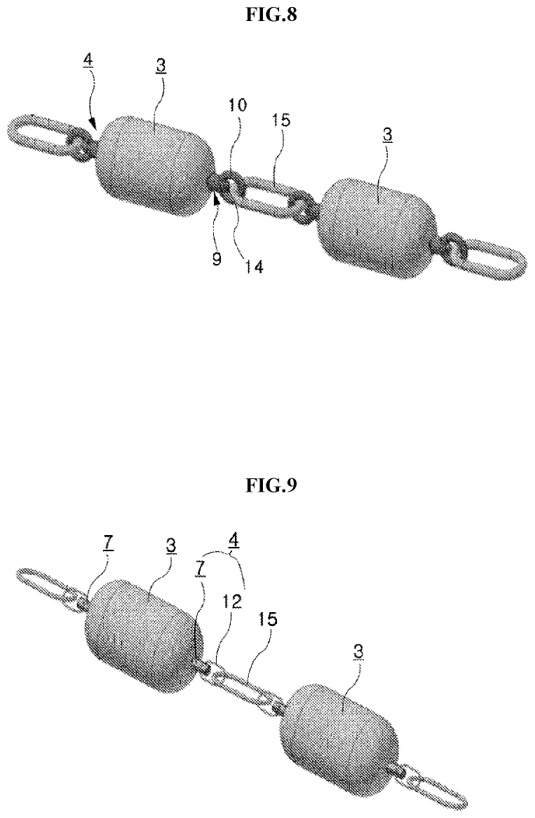

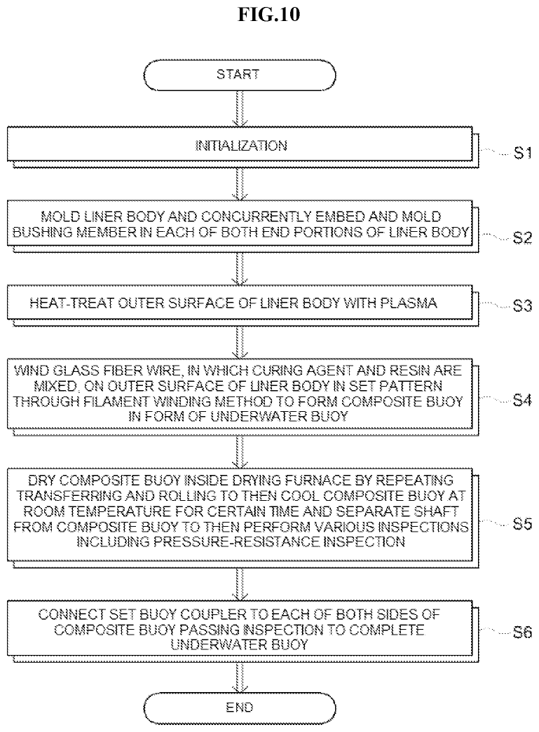

FIG. 2 is an explanatory view for describing one embodiment of a composite buoy according to an eco-friendly underwater buoy of the present invention. FIG. 3 is an explanatory view for describing another embodiment of a composite buoy according to an eco-friendly underwater buoy of the present invention. FIG. 4 is an image for describing an example of a liner body of an eco-friendly underwater buoy of the present invention. FIGS. 5A and 5B are explanatory views for describing one embodiment of FIG. 2 in more detail. FIGS. 6A and 6B are explanatory views for describing another embodiment of FIG. 3 in more detail. FIGS. 7A and 7B are explanatory views for describing an example of a filament winding pattern during a process of manufacturing an eco-friendly underwater buoy of the present invention. FIG. 8 is an explanatory view for describing a brief use state applied to the embodiment of FIG. 5A. FIG. 9 is an explanatory view for describing a brief use state applied to the embodiment of FIG. 5A. FIG. 10 is a flowchart of the present invention.

Referring to FIGS. 2 to 6, the underwater buoy of the present invention includes a hollow liner body 1, a winding member 2 which is melted and welded on an outer surface of the liner body through a winding method and absorbs an external impact, and a buoy coupler 4 which is formed to be embedded in each of both end portions of the liner body 1 and connects other adjacent underwater buoys 3 to each other.

Here, the liner body 1 may be made of high density polyethylene (abbreviated to HDPE). In this case, HDPE is polyethylene that is less branched, and has high crystallinity, and a density of 0.95 or more and has excellent hardness, mechanical strength, heat resistance, or the like but has slightly low workability. An industrial method of producing HDPE includes a low pressure method using an alkylaluminum-titanium halide as a catalyst (Ziegler method) and a medium pressure method using a silica-alumina-chromia catalyst (Phillips method). In addition, HDPE is non-toxic and eco-friendly plastic from which environmental hormones are not detected, has excellent strength, and is mainly used in manufacturing disposable shopping bags, various containers, toys, or the like. HDPE has (1) safety in which environmental hormones such as bisphenol, phthalate, and melamine are not detected at all, (2) durability in which, due to weight thereof, a product made of the HDPE is not easily tipped over and does not break easily even when dropped, and (3) heat resistance in which, due to no surface coating and high heat resistance temperature thereof, the HDPE is usable for a dishwasher.

Furthermore, the winding member 2 is a structure integrally formed on the outer surface of the liner body 1 by winding a wire made of a glass fiber in which a curing agent and a resin are mixed.

In addition, in one embodiment, as shown in FIGS. 5A and 5B, the buoy coupler 4 includes a bushing member 7 which is embedded in each of both end portions of the liner body 1 simultaneously when the liner body 1 is molded and includes a screw rod 5A with a rod shape including a male thread formed on an outer surface of one end portion of a body and a circumferential plate 6A with a certain diameter integrally formed under the screw rod 5A, and a coupling ring 10 which has a first nut coupling hole 8 formed to pass though an inner side thereof to a rear end thereof to have a certain diameter such that the screw rod 5A of the bushing member 7 is inserted therein and nut-coupled to the rear end and which is rotatably fixed to both external ends of a body 9 and is formed in a ring shape such that other objects are hung and coupled thereto.

Here, a female thread is formed inside the first nut coupling hole 8 so as to be screwed with the screw rod 5A of the bushing member 7.

In addition, in another embodiment, as shown in FIGS. 6A and 6B, the buoy coupler 4 includes a bushing member 7 which is embedded in each of both end portions of the liner body 1 simultaneously when the liner body 1 is molded and includes a screw rod 5B protruding outward in a rod shape and having a fixing hole 11 formed in one side of an end portion thereof and a circumferential plate 6A with a certain diameter integrally formed under the screw rod 5B, and a fixing wire 12 which is insertion-coupled to the fixing hole 11 of the bushing member 7 to serve as a hook.

Here, the fixing wire 12 may be fixed to the fixing hole with a slight clearance or without a clearance.

In addition, the bushing member 7 and the buoy coupler 4 may be made of an alloy or stainless steel (STS) material that does not rust.

Meanwhile, in the underwater buoy 3 according to the present invention, each member may be manufactured in various colors to have excellent visibility.

Next, a method of manufacturing an eco-friendly underwater buoy of the present invention will be described with reference to such a configuration.

As shown in FIG. 10, the method of manufacturing an eco-friendly underwater buoy of the present invention includes a first process S2 of molding and producing a liner body having a certain shape through a liner blower machine in an initial state 51 and concurrently embedding and molding a bushing member in each of both end portions of the liner body, a second process S3 of, after the first process S2, performing a liner flaming process of heat-treating an outer surface of the liner body with plasma, a third process S4 of, after the second process S3, coupling a shaft to the bushing member formed in the liner body and winding a glass fiber wire, in which a curing agent and a resin are mixed, on the outer surface of the liner body in a set pattern through a filament winding method to form a composite buoy in the form of an underwater buoy, a fourth process S5 of, after the third process S4, drying the composite buoy inside a drying furnace by repeating transferring and rolling to then cool the composite buoy at room temperature for a certain time and separating the shaft from the composite buoy to then perform various inspections including a pressure-resistance inspection, and a fifth process S6 of, after the fourth process S5, connecting a set buoy coupler to each of both sides of the composite buoy passing the inspection to complete an underwater buoy.

The first process S2 includes a liner molding process of molding and producing the liner body having the certain shape through the liner blower machine (not shown) and concurrently embedding and molding the bushing member in each of both end portions of the liner body, a scrap removing operation of, when the liner body is taken out to the outside in the liner molding operation, transferring the taken-out liner body to a set place through a conveyor (not shown) to then remove marks or scraps on the outer surface of the liner body, and a liner aging and drying operation of, after the scrap removing operation, performing an operation of drying and aging the liner body, from which the scraps are removed, at a set temperature for a set time through the conveyor (not shown) to write a dimension.

Meanwhile, the second process S3 further includes performing the liner flaming process of heat-treating the outer surface of the liner body with plasma.

Furthermore, the third process S4 includes a shaft coupling operation of coupling the shaft to the bushing member formed in the liner body, and a filament winding operation of, after the shaft coupling operation, allowing a plurality of glass fiber strands or wires, for example, 12 glass fiber strands or wires to pass through a mixing module (not shown) to be mixed with the resin and the curing agent and then filament-winding the mixed glass fiber wire in the set pattern on the outer surface of the liner body to form the composite buoy in the form of the underwater buoy.

In addition, the fourth process S5 includes a buoy drying operation of moving the composite buoy to the drying furnace using a moving means (not shown) coupled to the shaft and repeating transferring and rolling to dry the composite buoy, a cooling operation of, after the buoy drying operation, performing a process of exposing the dried composite buoy to air at room temperature for a certain time, for example, 15 minutes to 40 minutes, to cool the composite buoy, and a final inspection operation of separating the shaft from the composite buoy cooled in the cooling operation to then perform various inspections including the pressure-resistance inspection.

Meanwhile, the fifth process S6 includes a process operation of connecting the set buoy coupler to each of both sides of the composite buoy passing the inspection, for example, connecting a fixing wire or a coupling ring to each of both sides of the composite buoy to complete the underwater buoy according to the present invention.

In other words, in a manufacturing process of the underwater buoy of the present invention, in the first process S2, the liner body 1 having the certain shape is molded and produced through the liner blower machine (not shown), and at the same time, a bushing member 7 is formed in each of both end portions of the liner body 1. In this case, the molded liner body 1 is molded into a cylindrical shape that is the same as a shape of a composite material container. The liner body 1 refers to a cylinder before the winding operation of the third process S4 to be described below and may be referred to as a composite material container after the winding operation. In this case, the bushing member 7 is integrally embedded in each of both sides of the liner body during liner blow molding.

Furthermore, when the liner body 1 molded as described above is taken out to the outside, the taken-out liner body 1 is transferred to a set place through the conveyor (not shown), and then a process of removing marks or scraps on the outer surface of the liner body 1 is performed. In this case, in the scrap removing process, the scraps may be removed manually or may be removed using a scrap removal device.

As described above, the liner body 1 from which the scraps are removed is dried and aged at a set temperature for a set time while being moved through the conveyor (not shown) again, and then a process of writing the dimension is performed. That is, as described above, the liner body 1 from which the scraps are is moved to an aging place through the conveyor again to be left at room temperature for, for example, for 4 hours to 6 hours, and the liner body 1 made of HDPE as described above is dried and firmly aged at room temperature for a certain time. A dimension of the liner body 1, which is aged as described above, is inspected, that is, an overall length and outer diameter thereof are measured, and then the measured dimension is input to a computer (not shown).

Meanwhile, when the liner body 1 is taken out as described above, in the second process S3, the outer surface of the liner body 1 is heat-treated with plasma, and in the liner flaming process, the outer surface of the liner body 1 is heat-treated using oxygen plasma. The reason why the outer surface of the liner body 1 is heat-treated using oxygen plasma is to improve an effect of a winding process using a glass fiber in order to reinforce the strength of the outer surface of the liner body 1. That is, when the outer surface of the liner is heat-treated using oxygen plasma as described above, oxygen radicals, atoms, or molecules are irradiated onto the outer surface of the liner body 1 made of HDPE with high energy, and thus the outer surface of the liner body 1 is activated and charged. Therefore, in the winding operation of the third process S4 to be described below, the outer surface of the liner body is in an active state to be strongly combined with a glass fiber.

Further, in the third process S4, a shaft 13 is coupled to the bushing member 7 formed in the liner body 1 in order to facilitate the filament winding process. After the shaft is coupled as described above, the plurality of glass fiber strands or wires, for example, 12 glass fiber strands or wires are allowed to pass through the mixing module (not shown) and are mixed with the resin and the curing agent, and then the mixed glass fiber wire is filament-wound in the set pattern on the outer surface of the liner body 1 as shown in FIGS. 7A and 7B to form a composite buoy 3 in the form of an underwater buoy.

In other words, in the third process S4, since the surface of the liner body 1 is heat-treated with plasma in the second process S3, the glass fiber wire in which the curing agent and the resin are mixed is wound to be easily combined and integrated, and a cylinder of which strength is reinforced as described above is referred to as the eco-friendly composite buoy 3. Therefore, the eco-friendly composite buoy is manufactured by performing the winding process as described above, and the composite buoy is the same outer shape as the liner body 1, which is a raw material, but has strength sufficient to withstand internal pressure unlike the liner body 1.

In addition, in the fourth process S5, the composite buoy 3 subjected to the winding process is moved to the drying furnace (not shown) by the moving means (not shown) coupled to the shaft 13 and dried. In this case, the drying furnace is maintained at a constant temperature in a temperature range of, for example, 70° C. to 90° C. through an indirect heating method using a heater and a fan, and the moving means repeats the transferring and rolling of the composite buoy 3 to dry the composite buoy 3 in the drying furnace, for example, for 70 minutes to 90 minutes. In this case, the moving means performs a process of repeating moving and transferring while rolling the composite buoy 3 such that the glass fiber and resin wound on the outer surface of the composite buoy 3 are not biased to one side. After the drying of the buoy is finished as described above, the composite buoy 3 is exposed at room temperature for a certain time, for example, for 15 minutes to 40 minutes to perform cooling or a cooling process. In this case, a reason for performing the cooling as described above is to lower a surface temperature of the composite buoy to 35° C. or less, and the cooling is performed through a method of transferring the composite buoy 3 through a cooling conveyor (not shown) to hold the composite buoy 3 at room temperature for a certain time. Meanwhile, when the cooling process is finished in the fourth process S5, the shaft 13 is separated from the composite buoy 3. In this case, the separated shaft 13 is returned to an initial shaft coupling operation by the conveyor. When the shaft 13 is separated as described above, the pressure-resistance inspection is performed through a process of inspecting whether there is a leak (or leaking portion) by applying certain pressure to the composite buoy 3 for a certain time in a water tank, that is, water. In addition, after the pressure-resistance inspection, a process of identifying whether the composite buoy 3 is in a defective state through a visual inspection machine and identifying and recording a dimension is performed to pass only the good composite buoy 3.

Meanwhile, in the fifth process S6, a set buoy coupler 4, for example, a fixing wire 12 or a coupling ring 10, is connected to both sides of the composite buoy 3 passing the inspection, thereby completing the underwater buoy 3 according to the present invention.

Here, in embodiments in which the buoy coupler 4 is coupled to each of both sides of the underwater buoy 3 passing the inspection, there are two methods. First, in one embodiment, as shown in FIG. 5, a screw rod 5A of the bushing member 7 formed in each of both end portions of the underwater buoy 3 is inserted into a first nut coupling hole 8 formed to pass through the inside of a coupling ring 10 and then is allowed to pass through a rear end of the first nut coupling hole 8 to protrude therefrom. Since a nut 14 is coupled to a screw rod 5A or 5B protruding from the rear end of the first nut coupling hole 8 as described above, the coupling ring 10 is coupled to the underwater buoy 3. In this case, the coupling ring 10 is rotatably fixed to both external ends of a body 9 of the coupling ring 10 such that other objects such as ropes are hung and coupled thereto.

In another embodiment which the buoy coupler 4 is coupled to both sides of the underwater buoy 3, as shown in FIG. 6, a fixing wire 12 is inserted and fixed in a fixing hole 11 of the screw rod 5B of the bushing member 7 formed in each of both end portions of the heavy buoy 3. In this case, the fixing wire 12 may be fixed to the fixing hole with a slight clearance or without a clearance.

Therefore, when a use example of an eco-friendly buoy of the present invention as described above is further described, for example, when one embodiment of a ring type described with reference to FIGS. 5A and 5B is used in an actual workplace, as shown in FIG. 8, after another eco-friendly buoy 3 is disposed adjacent to a coupling ring 10 of an eco-friendly buoy 3, a connection member 15, for example, a connection means such as a rope (or a string for connecting a net) or an iron cord, is insertion-fixed to each coupling ring 10, thereby performing necessary work, for example, completing and using a necessary fishing net or aquaculture tool.

In addition, when an embodiment of a fixing wire type described with reference to FIGS. 6A and 6B is also used in an actual workplace, a shown in FIG. 9, after another eco-friendly buoy 3 is disposed adjacent to a fixing wire 20 of an eco-friendly buoy 3, a connection member 15, for example, a connection means such as a rope (or a string for connecting a net) or an iron cord, is insertion-fixed to each fixing wire 20, thereby performing necessary work, for example, completing and using a necessary fishing net or aquaculture tool.

Therefore, according to the present invention as described above, by manufacturing an underwater buoy by winding a wire in which a glass fiber, a resin, and the like are mixed, outside a liner structure through a filament winding method, the underwater buoy is made of a composite material and thus is not damaged from various impacts in the water to stably maintain an exterior of a buoy structure for a long time, thereby minimizing environmental pollution in water due to damage on the buoy structure. In other words, according to the present invention, since an underwater buoy is made of a composite material and installed, the underwater buoy has a long lifetime and also has very strong impact resistance and thus is not deformed due to water current or water pressure, thereby minimizing damage to fishing grounds and fishermen. In addition, even when the underwater buoy reaches the end of its lifetime or the use thereof is abolished, the underwater buoy is made of an eco-friendly material, thereby being collected and recycled as building bricks and asphalt paving materials.

Furthermore, in the present invention, since an underwater buoy has a structure in which a metal coupling means is formed in each of both end portions of an underwater buoy structure to couple other underwater buoy structures to each other, fishing net work and fish farm installation work can be easily performed, thereby obtaining the convenience of underwater work. Therefore, when an underwater buoy of the present invention is used, fishermen can attach an iron wire to a bushing member of a non-corrosive buoy coupler in each of both end portions of the buoy to easily couple the buoy to another buoy. In addition, according to the present invention, since an underwater buoy can be manufactured in a color desired by users such as fishermen, the fishermen can use the underwater buoys to perform various fishing net work or construct a shape of a fish farm so that the underwater buoy can satisfy various needs of the users.

1. An eco-friendly underwater buoy comprising:
a liner body having an inner hollow portion;
a winding member which is melted and welded on an outer surface of the liner body through a winding method and absorbs an external impact; and
a buoy coupler which is formed to be embedded in each of both end portions of the liner body and connects other adjacent underwater buoys to each other,
wherein the buoy coupler is embedded in each of the both end portions of the liner body simultaneously when the liner body is molded and includes:
a bushing member which includes a screw rod with a rod shape in which a male thread is formed on an outer surface of one end portion of a body, and a circumferential plate with a certain diameter integrally formed under the screw rod; and
a coupling ring which has a first nut coupling hole and which is rotatably fixed to both external ends of a body and is formed in a ring shape such that other objects are hung and coupled thereto, wherein the first nut coupling hole is formed to pass through an inner side of the coupling ring to a rear end thereof to have a certain diameter such that the screw rod of the bushing member is inserted and nut-coupled to the rear end and has a male thread formed inside the body such that the screw rod of the bushing member is screw-coupled thereto.

2. The eco-friendly underwater buoy of claim 1, wherein the liner body is made of high density polyethylene (HDPE).

3. The eco-friendly underwater buoy of claim 1, wherein the winding member is a structure formed integrally on the outer surface of the liner body by winding a wire made of a glass fiber mixed with a curing agent and a resin.

4. An eco-friendly underwater buoy comprising:
a liner body having an inner hollow portion;
a winding member which is melted and welded on an outer surface of the liner body through a winding method and absorbs an external impact; and
a buoy coupler which is formed to be embedded in each of both end portions of the liner body and connects other adjacent underwater buoys to each other,
wherein the buoy coupler is embedded in each of the both end portions of the liner body simultaneously when the liner body is molded and includes:
a bushing member which includes a screw rod protruding outward in a rod shape and having a fixing hole formed in one side of an end portion thereof and a circumferential plate with a certain diameter integrally formed under the screw rod; and
a fixing wire which is insertion-coupled to the fixing hole of the bushing member to serve as a hook.

5. The eco-friendly underwater buoy of claim 1, wherein the bushing member and the buoy coupler are made of any one selected from an alloy and stainless steel.

6. A method of manufacturing an eco-friendly underwater buoy, the method comprising:
a first process of molding and producing a liner body having a certain shape through a liner blower machine and concurrently embedding and molding a bushing member in each of both end portions of the liner body;
a second process of, after the first process, performing a liner flaming process of heat-treating an outer surface of the liner body with plasma;
a third process of, after the second process, coupling a shaft to the bushing member formed in the liner body and winding a glass fiber wire, in which a curing agent and a resin are mixed, on the outer surface of the liner body in a set pattern through a filament winding method to form a composite buoy having a form of an underwater buoy;
a fourth process of, after the third process, drying the composite buoy inside a drying furnace by repeating transferring and rolling to then cool the composite buoy at room temperature for a certain time and separating the shaft from the composite buoy to then perform various inspections including a pressure-resistance inspection; and
a fifth process of, after the fourth process, connecting a set buoy coupler to each of both sides of the composite buoy passing the inspection to complete an underwater buoy,
wherein the first process includes:
a liner molding process of molding and producing the liner body having the certain shape through the liner blower machine and concurrently embedding and molding the bushing member in each of the both end portions of the liner body;
a scrap removing operation of, when the liner body is taken out to the outside in the liner molding operation, transferring the taken-out liner body to a set place through a conveyor to then remove marks or scraps on the outer surface of the liner body; and
a liner aging and drying operation of, after the scrap removing operation, performing an operation of drying and aging the liner body, from which the scraps are removed, at a set temperature for a set time through the conveyor to write a dimension.

7. The method of claim 6, wherein the second process further includes a liner flaming operation of heat-treating the outer surface of the liner body using oxygen plasma.

8. The method of claim 6, wherein the third process further includes:
a shaft coupling operation of coupling the shaft to the bushing member formed in the liner body; and
a filament winding operation of, after the shaft coupling operation, allowing a plurality of glass fiber strands or wires to pass through a mixing module to be mixed with the resin and the curing agent and then filament-winding the mixed glass fiber wire in the set pattern on the outer surface of the liner body to form the composite buoy having the form of the underwater buoy.

9. The method of claim 6, wherein the fourth process further includes:
a buoy drying operation of moving the composite buoy to the drying furnace using a moving means coupled to the shaft and repeating the transferring and rolling to then dry the composite buoy;
a cooling operation of, after the buoy drying operation, performing a process of exposing the dried composite buoy to air at room temperature for 15 minutes to 40 minutes to cool the composite buoy; and
a final inspection operation of separating the shaft from the composite buoy cooled in the cooling operation to then perform the various inspections including the pressure-resistance inspection.

10. The method of claim 6, wherein the fifth process further includes a process operation of connecting any one of a fixing wire and a coupling ring to each of both sides of the composite buoy passing the inspection to complete the underwater buoy.

11. The eco-friendly underwater buoy of claim 4, wherein the bushing member and the buoy coupler are made of any one selected from an alloy and stainless steel.
